(19) United States
(12) Patent Application Publication
(10) Pub. No.: US 2016/0106631 A1
(43) Pub. Date: Apr. 21, 2016

(54) BITING AND COMFORTER DEVICE FOR INFANTS

(71) Applicant: MAM BABYARTIKEL GESELLSCHAFT M.B.H., Wien (AT)

(72) Inventor: Peter RÖHRIG, Wien (AT)

(21) Appl. No.: 14/759,067

(22) PCT Filed: Jun. 24, 2014
(86) PCT No.: PCT/AT2014/050141

§ 371 Date: Jul. 2, 2015

(30) Foreign Application Priority Data
Jun. 25, 2013 (AT) GM 50093/2013

(51) Int. Cl. A61J 17/02; A61J 17/00

(52) U.S. Cl. CPC A61J 17/02; A61J 17/007

(57) ABSTRACT

The invention concerns a biting and comforter device (3) for infants, with a cloth (1) which has at least one slit-like aperture (6), and with at least one biting element (2) which comprises at least one peripherally closed through-aperture (16), the through-aperture (16) and the slit-like aperture (6) being configured such that a section (20) of the cloth (1) can be passed both through the through-aperture (16) in the biting element (2) and through the slit-like aperture (6) in the cloth (1) such that the biting element (2) can be connected to the cloth (1) in a loop-like arrangement of the cloth (1).

The invention relates to a biting and comforter device for infants, with a cloth which has at least one slit-like aperture.

A plurality of devices in the field are already known in the state of the art. Comforter cloths and comforter blankets as well as teething rings are, for instance, used by many mothers in child care. The respective separately achieved advantages are therefore well-known.

The combination of a biting device with a comforter device is, in the case of a permanent connection, problematic among others from a hygienic point of view since the hygienic handling and cleaning of the two devices are completely different. For the comforter cloth, cleaning in a washing machine is advisable. However, there is the risk that the biting device which has to be of a certain size so as not to be swallowed by the child damages the drum of the washing machine during the cleaning of a combined device. If the biting device is made smaller so as not to damage the washing drum and is connected with the cloth allegedly permanently, e.g. by means of a seam connection, there is in turn the risk that this connection is loosened unintentionally. In this case, the danger of suffocation is substantial for an infant unless the biting device is designed for a separation of the two elements.

U.S. Pat. No. 6,189,166 B1 discloses a comforter cloth with a small slit in a corner, wherein the slit runs in parallel to a diagonal from the closest corner to the middle of the cloth. By means of the slit the cloth may be connected directly by a button to the clothes of the infant or by a holding band, for instance, to be fastened on a child's seat. The fastening of the cloth is to prevent slipping, dropping or loss of the cloth.

U.S. Pat. No. 6,292,962 illustrates a comforter cloth comprising biting elements of a harder plastics material in the corner regions. Moreover, a snapping element which provides a receiving aperture for fastening a nipple may be sewed on the edge of the comforter cloth.

US 2008/0134432 A1 also discloses a comforter cloth, wherein this comforter cloth comprises in a corner region a loop element with a closure device on which loop element a pacifier or a biting element may be fastened.

U.S. Pat. No. 5,522,849 discloses a comforter cloth on which a nipple element is clamped.

U.S. Pat. No. 7,254,849 B1 describes a diaper for wrapping an infant in, comprising a bag for accommodating the child. The diaper comprises a slit on one side through which the opposite side of the diaper is passed and can be fastened to the rear side by means of a hook and loop fastener.

A biting device that is connected with a mitten is known from US 2007/0288056 A1, wherein the mitten serves to fasten the biting device to an infant's hand. A comforter device is not disclosed here, though.

As compared to the known devices it is an object of the invention to provide a biting and comforter device of the initially-mentioned kind, wherein the cloth is adapted to be connected directly and without other connection elements, such as for instance buttons, bands, or the like, with the biting device and can at the same time be detached from the biting device in a simple manner.

In accordance with the invention this object is solved in that at least one biting element is provided which comprises at least one peripherally closed through-aperture, wherein the through-aperture and the slit-like aperture are configured such that a section of the cloth can be passed both through the through-aperture in the biting element and through the slit-like aperture in the cloth such that the biting element can be connected to the cloth in a loop-like arrangement of the cloth.

This loop-like arrangement has the advantage that an extremely reliable connection is achieved and that only minor modifications of the cloth are required at the same time. The production of the slit-like aperture involves hardly any additional effort since it may, for instance, be processed comparably to the edge of the cloth. Accordingly, the combination device according to the invention is composed of a comforter cloth and a biting device which can be connected with each other in a simple manner, but whose connection may also be released in a simple and quick manner. It is therefore possible to clean the comforter cloth—without the biting device—without problems in the washing machine without the risk of damage to the washing drum. If, however, the two elements are connected with each other, the device offers what is essential for any infant: a soft, cuddly element for cuddling which may, for instance, consist of cotton, natural fibers, or the like, and a hard element for mitigating the pain of the teething infant. Moreover, the infant will closely watch his or her parents when making the loop-like connection and will try to imitate what he or she has seen, so that the infant's dexterity will also be improved.

For the loop formation it is of advantage if the cloth comprises at least three, in particular four, corners and if at least one, preferably one single, slit is provided in the region of one of the corners of the cloth. The corners facilitate the passing of a section of the cloth through the slit-like aperture since they have a smaller cross-section than a rolled-up edge of the cloth, for example. In the case of four corners a symmetrical loop may advantageously be produced in that the corner opposite to the slit-like aperture is the first to be passed through the aperture. Even if basically several slits may be provided, a loop is expediently only formed through one slit, so that one single slit in the cloth is sufficient and constitutes the least manufacturing effort.

If the slit-like aperture is arranged transversely to its imaginary line between the closest corner and a central point of the cloth, it is particularly easy to pass through a section of the cloth since in this case only a slight or small twisting of the cloth is required apart from the “rolling in” necessary for loop formation.

In order to make the device attractive for an infant, one side of the cloth may consist of a plush material. The resilience during cuddling to the infant's skin achieved thereby is usually felt to be particularly comfortable and increases the likelihood that the entire device is accepted by a child.

A higher recognition value and an increased interest of the child may additionally be achieved if at least one side of the cloth comprises image motifs. The image motifs provide an activity and play opportunity for the child, for instance, by recognizing and denominating the abstract shapes. Moreover, if different designs are available, the image motifs enable a differentiation if several children and/or cloths are involved at the same time.

For a simple manufacturing and storing it is favorable if the cloth has a rectangular, in particular a square, shape. The rectangular shape enables a place-saving folding of the cloth and hence a compact storage. In the case of a square shape the cloth formed as a loop comprises at least two lappets of substantially equal length, so that an optically attractive appearance similar to a cuddly toy is conveyed even in the loop state.

For the use by infants it is favorable if at least one edge length of the comforter cloth is between 20 and 40 cm, in particular approximately 30 cm. With this size the cloth may also serve as a comforter blanket without, however, aggravating the use of the biting element due to a too large extension.

In order not to stimulate the chewing on the corners of the comforter cloth, in particular on the corner with the slit-like aperture which is closest to the biting element in a loop state, on the one hand, and in order to achieve an optically attractive appearance, on the other hand, the corners of the cloth may be rounded with a radius between 1 cm and 5 cm, in particular with a radius of approximately 3 cm.

It is further of advantage if the slit is contrasted in color on at least one side of the cloth with respect to the remaining cloth face. Thus, it is easy for a carer to find the slit without searching and the device is quickly ready for use.

The biting element may be a teething ring, preferably a teething ring substantially in the shape of an eight. A teething ring is the simplest form adapted to be permanently connected with a loop and additionally offers the possibility of different biting regions along the ring. The shape of an eight corresponds substantially to two integrally connected teething rings, but has the additional advantage over the teething ring that the through-aperture through which the cloth is not passed in a loop state can be used by the child completely and from any side. Moreover, the cloth may be passed through the two apertures of the teething ring such that the cloth is first of all passed through one aperture and then—on the same side of the teething ring—enters the other aperture such that the comforter cloth then receives the teething ring like a clasp. Thus, a further attractive combination state can be achieved in addition to the loop state.

A maximum thickness between 3 and 8 mm, preferably 5 mm, and/or a length between 50 and 100 mm, preferably 85 mm, and/or a breadth between 30 and 80 mm, preferably 50 mm have turned out to be advantageous dimensions of the teething ring. These dimensions are oriented at the size of the oral cavity and of the set of teeth of an infant such that the teething ring can be used with teeth in any position.

For a varied massage of the gingiva and/or of the teeth it is beneficial if an external surface of the biting element comprises profile elements. By means of the profile elements it is possible to also reach and massage interdental spaces, and it is possible to obtain regions of the biting element which are of different hardness. The biting element may, for instance, consist of an elastomeric plastics material, latex, silicone, or the like.

In the following, the invention will be further explained by means of particularly preferred embodiments on which it is not intended to be restricted, though, and with reference to the drawing. The drawings show in detail:

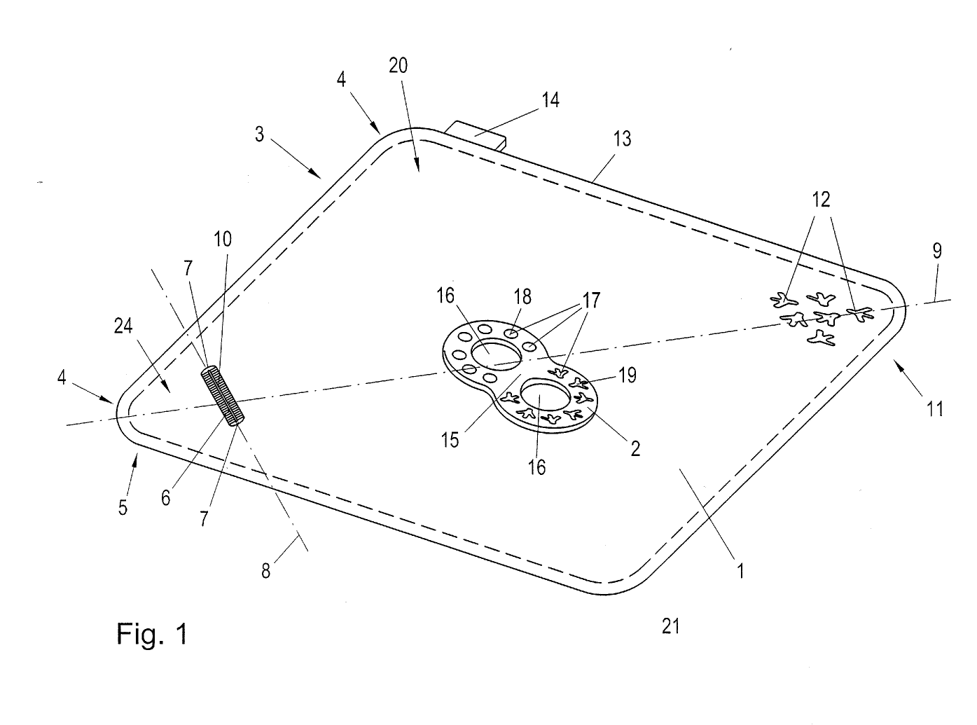

FIG. 1 the biting and comforter device in accordance with the invention in a separated storage and/or delivery state;

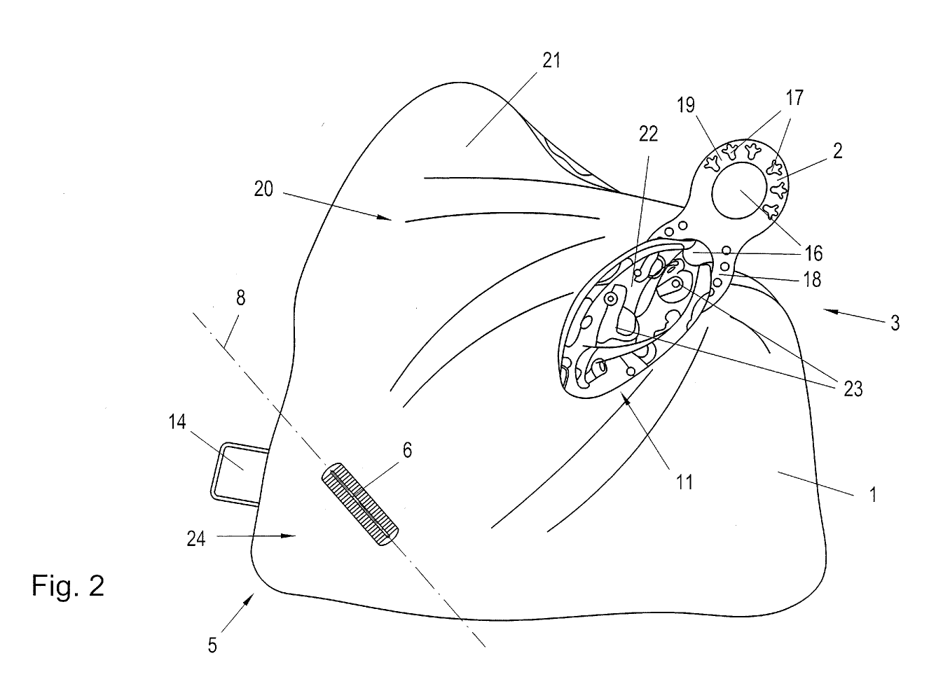

FIG. 2 the device according to FIG. 1 at the beginning of the loop formation; and

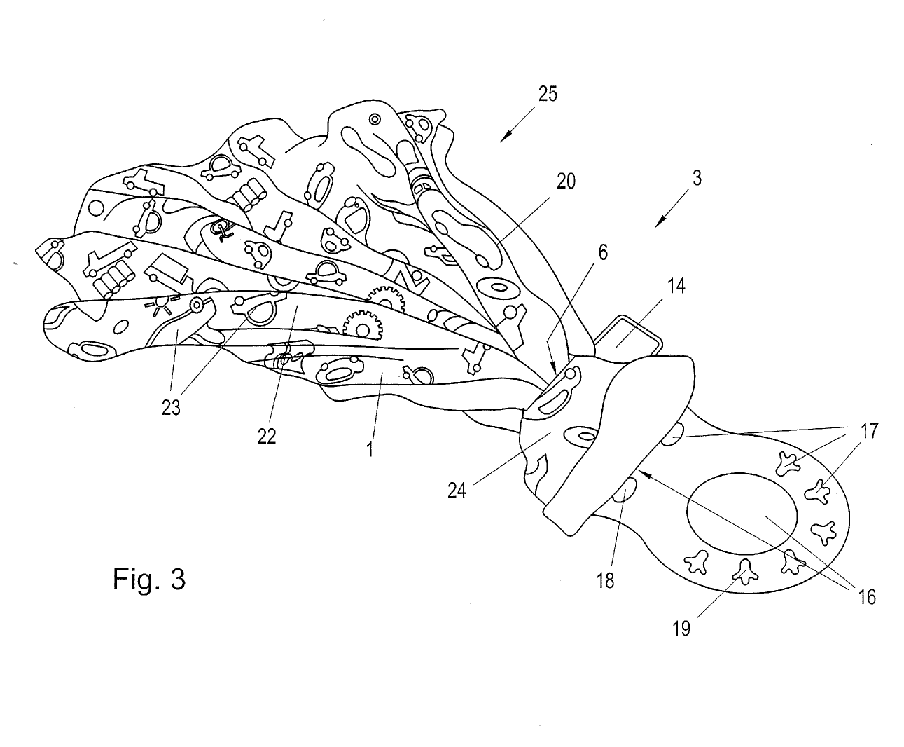

FIG. 3 the device according to FIGS. 1 and 2 in a loop state.

FIG. 1 illustrates the cloth 1 and the biting element 2 of the device 3 according to the invention one on top of the other. In this state the device 3 assumes the smallest space, wherein the cloth 1 may, for instance, additionally be folded for the sake of compact storage. In the illustrated preferred embodiment the cloth 1 has a substantially square shape with four rounded corners 4. In the region of the one corner 5 the cloth 1 has a slit-like aperture 6. The length of the aperture 6 corresponds approximately to one seventh of the edge length of the cloth 1. The distance of the two ends 7 of the aperture 6 from the edge of the cloth 1 along the slit axis 8 corresponds on both sides approximately to the length of the aperture 6. The slit-like aperture 6 is arranged transversely to the diagonal 9 of the cloth 1 running through the middle thereof. The edge 10 of the aperture 6 is seamed and/or stitched down with respect to the cloth face, wherein the color of the seam is in contrast to the color of at least one side of the cloth 1 and emphasizes the position of the aperture 6, so that it can be recognized at a glance.

In the region of a corner 11 opposite to the aperture 6 the cloth 1 comprises decorative elements 12 which constitute an optical counterbalance of the emphasized slit-like aperture 6, but cannot be mixed up with the aperture 6. A label 14, for instance a fabric label, with a manufacturer information and possibly a maintenance instruction is fixed to an outer edge 13 of the cloth 1.

In FIG. 1 the biting element 2 lies on the flat spread cloth 1. The shape of the biting element 2 corresponds to the shape of an eight, wherein a central portion 15 has less strength than the rest of the biting element 2. The biting element 2 comprises two substantially circular through-apertures 16. Profile elements 17 are arranged at the upper and lower sides of the biting element 2, wherein the profile elements 17 of the two opposite ring portions 18, 19 have different shapes. The one ring portion 18 is provided with circular profile elements 17 of different diameters and the other ring portion 19 is provided with profile elements 17 resembling impressions of a bird's foot. The shape of the profile elements 17 of this ring portion 19 matches the shape of the decorative elements 12 on the cloth 1 such that the affiliation of the biting element 2 with the cloth 1 is emphasized. The diameter of the through-apertures 16 is geared to the slit-like aperture 6 of the cloth 1 since substantially the same cloth portion 20 has to be passed through both of them during the formation of a loop.

FIG. 2 illustrates the beginning of the loop formation, wherein the corner 11 of the cloth 1 opposite to the slit-like aperture 6 was passed through a through-aperture 16 of the biting element 2 and in the direction of the slit-like aperture 6. As can be seen, the cloth 1 comprises, apart from a plush side 21, also an opposite side 22 with colored image motifs 23 which side is formed by a textile material. Accordingly, it is understood that the cloth 1 may have several layers. After the corner 11 also having been passed through the slit-like aperture 6, the loop may be closed tightly about the receiving ring portion 18 by continuous pulling on the corner 11 (cf. FIG. 3). As may be understood from FIG. 2, the through-aperture 16 of the biting element 2 and the slit-like aperture 6 on the cloth 1 have to enable the pulling through of almost the entire cloth 1. The section 20 that can be passed through thus corresponds substantially to the entire cloth 1 with the exception of the corner region 24 of the corner 5 which is arranged adjacent to the slit-like aperture 6 in the flat state of the cloth 1 (cf. FIG. 1), wherein the corner region 24 is restricted in the direction of the middle of the cloth by the axis 8 of the slit-like aperture 6. If it has to be ensured that the child gets the device only when the cloth 1 and the biting element 2 are in the connected state, the loop may be tied down with force after the steps of passing through and formation of a loop such that—if desired—the connection of the biting and comforter device 3 cannot be released easily by the child.

In FIG. 3 the device 3 according to the invention is illustrated in a loop and/or use state. The section 20 of the cloth 1 which can be passed through has been passed completely through a through-aperture 16 and the slit-like aperture 6 in the cloth 1. The ring portion 18 of the biting element 2 which is arranged in the loop is wrapped by the cloth loop while the opposite ring portion 19 is freely accessible.

As may be seen in FIG. 3, the cloth 1 comprises image motifs 23 on a side 22 opposite to the plush side 21, said image motifs representing different vehicles in the instant case. The cloth 1 forms an apron starting out from the biting element 2 which has an approximately constant length due to the square shape of the cloth 1 and may be used as a blanket during biting. Since the majority 20 of the cloth 1 would have to be passed back through the cloth slit 6 and the through-aperture 16 in the biting element 2 for releasing the connection between the biting element and the comforter cloth, the construction illustrated here is, on the one hand, very stable and cannot be released by an infant. On the other hand, it nevertheless enables a carer to exchange the cloth 1 or the biting element 2 and to clean both elements separately, for instance.

In order to prevent the label 14 on the cloth 1 from being passed through the through-aperture 16 and the slit-like aperture 6, which may be useful in particular in the case of larger or somewhat rigid labels, it may be positioned at a region 24 that cannot be passed through, for instance, at the edge of the same corner 5 as the slit-like aperture 6.

Furthermore, the cloth 1 may—in a combination state that is not illustrated—also be threaded through the two through-apertures 16 of the teething ring 2. In this process, the cloth is first of all passed through one aperture 16. Subsequently the cloth is—at the same side of the teething ring 2 at which the cloth passed through before—introduced into the other aperture 16 such that the cloth 1 receives the teething ring 2 like a clasp. Thus, another attractive combination state may be achieved in addition to the loop state. It is to be understood that further variants of connection are also possible.

1. A biting and comforter device for infants, with a cloth which has at least one slit-like aperture, characterized in that at least one biting element is provided which comprises at least one peripherally closed through-aperture, the through-aperture and the slit-like aperture being configured such that a section of the cloth can be passed both through the through-aperture in the biting element and through the slit-like aperture in the cloth such that the biting element can be connected to the cloth in a loop-like arrangement of the cloth.

2. The biting and comforter device according to claim 1, characterized in that the cloth comprises at least three, in particular four, corners and in that at least one, preferably one single, slit is provided in the region of one of the corners of the cloth.

3. The biting and comforter device according to claim 1, characterized in that the slit-like aperture is arranged transversely to its imaginary line between the closest corner and a center point of the cloth.

4. The biting and comforter device according to claim 1, characterized in that one side of the cloth consists of a plush material.

5. The biting and comforter device according to claim 1, characterized in that at least one side of the cloth comprises image motifs.

6. The biting and comforter device according to claim 1, characterized in that the cloth has a rectangular, in particular a square, shape.

7. The biting and comforter device according to claim 1, characterized in that at least one edge length of the cloth has between 20 and 40 cm, in particular approximately 30 cm.

8. The biting and comforter device according to claim 1, characterized in that the corners are rounded with a radius between 1 cm and 5 cm, in particular with a radius of approximately 3 cm.

9. The biting and comforter device according to claim 1, characterized in that the slit-like aperture is contrasted in color on at least one side of the cloth with respect to the remaining cloth face.

10. The biting and comforter device according to claim 1, characterized in that the biting element is a teething ring, preferably a teething ring substantially in the shape of an eight.

11. The biting and comforter device according to claim 10, characterized in that the teething ring has a maximum thickness between 3 and 8 mm, preferably 5 mm, and/or a length between 50 and 100 mm, preferably 85 mm, and/or a breadth between 30 and 80 mm, preferably 50 mm.

12. The biting and comforter device according to claim 1, characterized in that an external surface of the biting element comprises profile elements.

13. A method for forming a biting and comforter device according to claim 1, wherein the section of the cloth which can be passed through is passed through a through-aperture of the biting element and subsequently through a slit-like aperture in the cloth such that the cloth forms a loop through the biting element and the biting element is connected with the cloth.

14. The method according to claim 13, characterized in that the section of the cloth which can be passed through is passed through a through-aperture of the biting element starting with a corner opposite to the slit-like aperture, and subsequently through a slit-like aperture in the cloth.

15. The biting and comforter device according to claim 2, characterized in that the slit-like aperture is arranged transversely to its imaginary line between the closest corner and a center point of the cloth.

16. The biting and comforter device according to claim 2, characterized in that one side of the cloth consists of a plush material.

17. The biting and comforter device according claim 2, characterized in that at least one side of the cloth comprises image motifs.

18. The biting and comforter device according to claim 2, characterized in that the cloth has a rectangular, in particular a square, shape.

19. The biting and comforter device according to claim 2, characterized in that at least one edge length of the cloth has between 20 and 40 cm, in particular approximately 30 cm.

20. The biting and comforter device according to claim 2, characterized in that the corners are rounded with a radius between 1 cm and 5 cm, in particular with a radius of approximately 3 cm.
